(19) United States
(12) Patent Application Publication
(10) Pub. No.: US 2011/0011004 A1
(43) Pub. Date: Jan. 20, 2011

(54) Set of seals for a door

(76) Inventors: Cèdric Courrian, La Guepiere (FR); Benoit Orlandini, Tours (FR)

Correspondence Address: DAVID R PRESTON & ASSOCIATES APC, 5850 OBERLIN DRIVE, SUITE 300, SAN DIEGO, CA, 92121, US

(21) Appl. No.: 12/799,271

(22) Filed: Apr. 21, 2010

(30) Foreign Application Priority Data
Apr. 21, 2009 (FR) FR 09/01924

(51) Int. Cl. E06B 7/16

(52) U.S. Cl. 49/483.1

(57) ABSTRACT

The invention concerns a set of seals for a door with two opening leaves (3, 4) or one opening leaf and one fixed leaf comprising a male seal (1) and a female seal (2). This set of seals is provided with a device for detecting that a thin object is wedged between the male seal and the female seal by virtue of the use of a single pressure sensor (7). To this end, the male seal comprises a bearing surface (6) and a pressure sensor (7) projecting from the bearing surface (6), while the female seal comprises a cavity (18) delimited by two branches (16, 17) between which the pressure sensor is inserted when the set of seals is in the nominal closed position. The male seal and female seal thus form between them an empty space (28) with a cross section in the form of Ω into which the thin object passes. By virtue of this empty space, any tension exerted on the thin object is converted into compression of the pressure sensor.

### TECHNICAL FIELD OF THE INVENTION

The invention concerns a set of seals for a door with at least one opening leaf, and a door provided with such a set of seals.

### PRIOR ART

Public transport vehicles, for example rail vehicles, and in particular suburban or metro trains, are provided with doors with two leaves that slide in the direction of each other to close.

When the doors close, an object may be jammed between the door seals and a user may be trapped by the doors because of this object.

To prevent the vehicle departing, to trigger an alarm and/or to cause the doors to reopen automatically, the door seals are equipped with presence detectors that change state when an object is wedged between the door seals. However, certain cases of wedging of objects are difficult to detect with traditional systems, in particular when flexible thin objects of the leash, tie or scarf type are trapped between the leaves. However, it frequently happens that thin objects of this type are wedged between the seals of the two door leaves. The user may then be trapped by the door through this flexible thin object. It is when the closure of the doors is checked visually by the train driver or the station manager that this type of incident is detected, but automatic detection is still desirable.

To overcome this type of problem, the majority of train or metro doors are equipped with seals for preventing users being dragged. These seals comprise detectors for detecting the presence of an object, even if the latter is thin, between the door seals. Such a seal for preventing dragging of users is for example described in the document CH 688 354.

However, such a seal requires the use of two sensors and does not allow detection of objects at 180°. In addition, it detects objects only if a sufficiently high tension is exerted on them. Reliability is therefore not optimum. If it is wished to increase the sensitivity of the device, there is a risk moreover of making false detections, which impairs the availability of the system.

### DISCLOSURE OF THE INVENTION

The invention aims to remedy the drawbacks of the prior art by proposing a set of door seals that is simple and reliable, preventing passengers from being dragged when the doors are closed and a flexible thin object of the tie, jacket or scarf type is wedged between the door seals.

More precisely the invention concerns a set of seals for a door with at least one leaf, the set of seals comprising a male seal and a female seal, the male seal defining a translation axis, the male seal and the female seal being able to be moved in translation with respect to each other along the translation axis between an open position and a nominal closed position, the set of seals being such that:
the male seal comprises:
   a bearing surface,
   a pressure sensor projecting from the bearing surface in the direction of the female seal, the bearing surface extending on each side of the pressure sensor,
the female seal comprises:
   a bottom disposed opposite the pressure sensor of the male seal,
   two branches disposed on each side of the bottom in order to delimit with the bottom a cavity having a U-shaped cross section open in the direction of the male seal.

Characteristically, the male seal and the female seal are arranged so that, in the nominal closed position:
the space between the male seal and the female seal is closed at the bearing surface of the male part,
the pressure sensor enters the cavity without there being any contact between the pressure sensor and the walls of the cavity.

When the set of seals according to the invention is in the closed position, or in the nominal closed position, the space between the male seal and the female seal forms a double chicane: this is because the space at the cavity of the female seal and of the pressure sensor has a concavity turned towards the male seal, while the spaces formed at the branches of the female part each have a concavity turned towards the female seal. This double chicane has two change-of-direction points on each side of the pressure sensor:
the first change-of-direction point is situated between the bottom of the cavity and the internal free end of a first of the two branches,
and the second change-of-direction point is situated between the bottom of the concavity and the internal free end of the other branch.

When a thin object is wedged between the male seal and the female seal, this thin object passes through the chicane and undergoes a double change of angle, so that the part of the thin object wedged at the pressure sensor exerts on it a force parallel to the translation axis. With a single pressure sensor parallel to the translation axis, the set of seals according to the invention can therefore detect any flexible thin object, whatever the direction of the force that is exerted on it. This is because, when a force is exerted on a flexible thin object, whatever the direction of this force, the latter is converted into a force parallel to the translation axis by the double chicane. Any tension exerted on the flexible thin object has a transverse component and a component parallel to the translation axis. The component parallel to the translation axis is not converted by the chicane. As for the transverse component, this is converted into a component parallel to the translation axis by the chicane. In this way a path is created for the thin object between the male seal and the female seal so that its transverse movement is sensed by a pressure sensor parallel to the translation axis.

The set of door seals according to the invention therefore requires the use of only one sensor and detects the wedged objects whatever the direction of the tension exerted on them, and hence a saving in means. Preferentially, the female seal therefore has no sensor, although it can in theory be envisaged providing a second sensor integrated in the female seal in order to provide redundancy for example.

Moreover, the space between the male seal and the female seal is closed so that the set of seals also fulfils the primary function of impermeability to water, dust and wind.

The pressure sensor must not be in contact with the walls of the cavity so that the walls of the cavity do not exert any pressure on the sensor and there is no unwanted triggering of the pressure sensor when there is no thin object wedged between the male seal and the female seal. The pressure sensor is sufficiently far away from the walls of the cavity to prevent the walls of the cavity bearing on the sensor, even in the case of faulty adjustment.

In order to optimise the transformation of a transverse tension on the thin object constrained parallel to the translation axis on the pressure sensor, even when there are defects in adjustment, it is preferable for the pressure sensor to enter deep into the cavity.

The male seal and the female seal are preferably produced from an elastic material of the rubber type.

The branches of the female seal are preferably sufficiently rigid not to deform when a thin object of the tie type exerts a force on them. In this way, the thin object bears on the branches to exert a force parallel to the translation axis on the pressure sensor.

The surface of the pressure sensor is preferably deformable so as to deform under compression when a thin object exerts a force on the pressure sensor.

Thus, when a thin object is wedged in the space between the male seal and the female seal, the branches of the male seal deform very little while the surface of the pressure sensor deforms under compression.

Advantageously, the cavity of the female part is conformed so as to delimit, with the bearing surface and the pressure sensor, an empty space having a cross section in the form of Ω.

The branches of the female part delimit the feet of the Ω, while the walls of the cavity delimit the head of the Ω. This Ω shape in the space between the male seal and the female seal forces the thin object to pass through a path comprising two very marked change-of-direction points, which enables the thin object to bear on the pressure sensor, along the translation axis, when a tension is exerted on the thin object.

Advantageously, the pressure sensor comprises an end provided with a rib projecting from the wall of the pressure sensor in the direction of the cavity of the female seal.

The rib on the end of the pressure sensor makes it possible to locate the pressure generated by the thin object on a precise point on the pressure sensor instead of distributing it over the entire surface of the pressure sensor.

Advantageously, the rib comprises a flat end.

The rib preferably has a rectangular-shaped cross section.

Advantageously, the bottom of the female seal is flat and is disposed facing the flat end of the rib when the set of seals is in the nominal closed position.

The set of seals preferably comprises a transverse axis perpendicular to the translation axis, the flat bottom having dimensions along the transverse axis greater than those of the flat end of the rib.

In this way the set of seals according to the invention can detect an object wedged between the male seal and the female seal, even when there is faulty adjustment along the transverse axis.

More generally, is it advantageous that the flat bottom has a shape complementary to the end of the rib that faces it so as to enable detection even in the case of faulty adjustment.

Advantageously, the flat bottom has dimensions along the transverse axis at least twice as great as those of the flat end of the rib.

Advantageously, the cavity and the pressure sensor are sized so that, when the set of seals is in the nominal closed position, the end of the rib is situated at a distance d1 from the bottom of the cavity such that:

0.5<d1<3 mm

Advantageously, the set of seals is such that the pressure sensor comprises two lateral walls, each lateral wall facing an internal wall of one of the branches of the female seal, the cavity and the pressure sensor being sized so that, when the set of seals is in the nominal closed position, the lateral wall of the pressure sensor is situated at a distance d2 from the internal wall of one of the branches of the female seal such that:

0.1 mm<d2<3 mm

In this way, the space between the rib and the bottom of the cavity is sufficiently great to allow defects in adjustment without the walls of the cavity bearing on the pressure sensor, but the pressure sensor enters sufficiently into the cavity for a thin object jammed between the male seal and the female seal to be constrained between the branches of the female part and the pressure sensor.

According to a preferential embodiment of the invention, the set of seals is noteworthy in that:
each branch of the female part comprises an internal rim at the edge of the cavity,
when the set of seals is in the nominal closed position, the distance between the end of the rib and a straight line passing through the two internal rims is greater than half the distance between the two internal rims.

In this way, the two change-of-direction points of the chicane formed between the male seal and the female seal are situated at the two internal rims and are very marked so that the thin object bears greatly on the pressure sensor when a tension is exerted on it.

The internal rim is formed between the surface of the branches that faces the bearing surface and the lateral walls of the branches that form the internal walls of the cavity. This internal rim is preferably rounded in order not to tear a thin object wedged between the male and female seals.

Advantageously, the seal comprises flexible sealing lips closing the space between the male seal and the female seal.

These sealing lips prevent the passage of water and dust between the male and female seals.

The male seal preferably comprises a first flexible sealing lip arranged so that:
the first sealing lip projects from the bearing surface;
the first sealing lip comes into contact with a first of the branches of the female seal;
the first sealing lip is inclined so as to be directed in the direction of the cavity.

The female seal preferably comprises a second flexible sealing lip arranged so that:
the second sealing lip projects from the second of the branches of the female seal;
the second sealing lip comes into contact with the bearing surfaces;
the second sealing lip is inclined so as to be directed in the direction of the pressure sensor.

The guide lips jut towards the space lying between the two seals so as to prevent the entry of water or dust between the two seals.

Advantageously, the first branch of the female seal comprises a surface that faces the first sealing lip and is slightly sloping in the direction of the cavity. “Slightly sloping” means a slope of between 3° and 35° with respect to the transverse axis.

Likewise, the bearing surface that faces the second sealing lip is preferably slightly sloping in the direction of the base of the pressure sensor.

Thus, in both cases, the parts of the seals that receive the sealing lips are slightly sloping in order to enable the lip to be guided towards the space lying between the male seal and the female seal and to prevent the lip from turning over.

The invention also concerns a door comprising at least a first opening leaf and a fixed leaf or a second opening leaf and is provided with a set of seals as previously described, the male seal being secured to the first opening leaf, the female seal being secured to the fixed leaf or the second opening leaf.

Each seal, male and female, is preferable secured to the corresponding opening door leaf by means of a clipping system.

The invention is particularly suited to the doors of rail vehicles, such as trains, trams and metro trains.

### BRIEF DESCRIPTION OF THE FIGURES

Other features and advantages of the invention will emerge from a reading of the following description, with reference to the accompanying figures, which illustrate:

FIG. 1, a view in section of a set of seals according to a first embodiment of the invention, the set of seals being in the nominal closed position;

FIG. 2, a view in section of the set of seals of FIG. 1 in a closed position offset with respect to the nominal position;

FIG. 3, a view in section of the male seal in the set of seals of FIG. 1;

FIG. 4, a view in section of the female seal in the set of seals in FIG. 1;

FIG. 5, a view in section of the set of seals of FIG. 1 in which a thin object is wedged;

FIG. 6, a view in section of a set of seals according to another embodiment of the invention.

For more clarity, the identical or similar elements are indicated by identical reference signs on all the figures.

### DETAILED DESCRIPTION OF AN EMBODIMENT

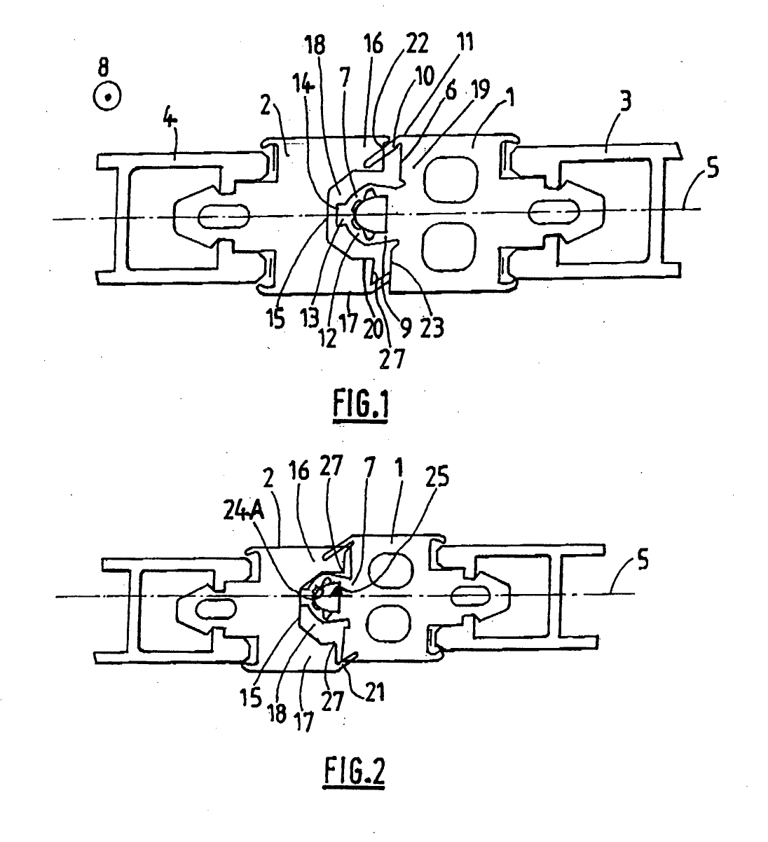

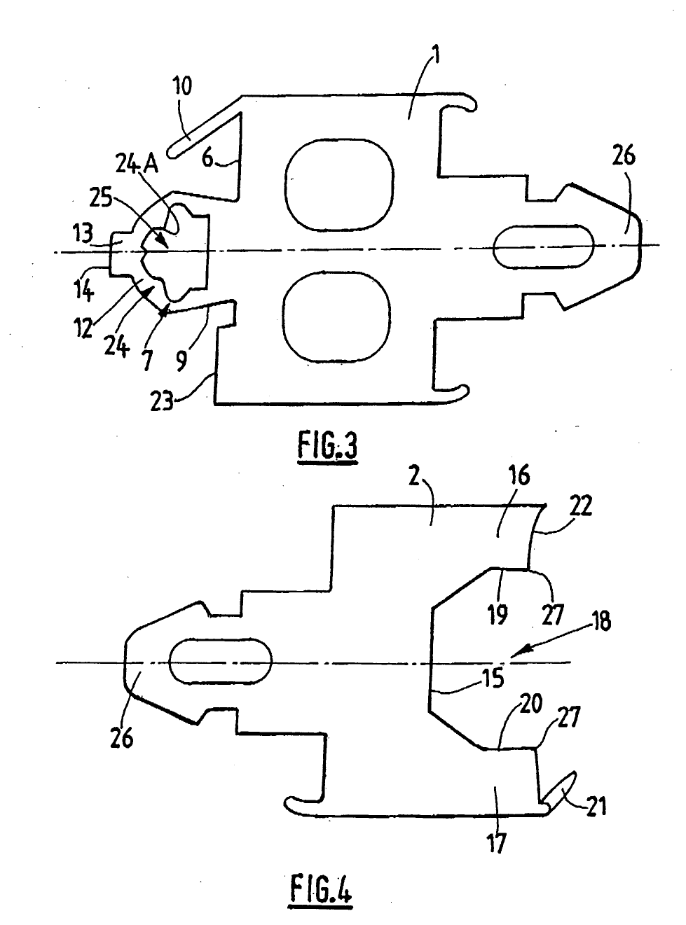

With reference to FIGS. 1 to 5, the set of seals according to the invention comprises a male seal 1, shown more precisely in FIG. 3, and a female seal shown more precisely in FIG. 4. The male seal 1 is secured to a first opening door leaf 3 and the female seal 2 is secured to a second opening door leaf 4. The door leaves 3 and 4 are able to move along a translation axis 5 or in a translation and a zigzag, just like the male 1 and the female 2 seals that are secured to the door leaves. Thus all the seals can pass from an open position to a nominal closed position shown in FIG. 1. In the remainder of the description it will be considered that the axis 5 is linked to the male seal 1.

The male and female seals extend vertically along the axis 8. Hereinafter, the adjective “vertical” will designate a direction parallel to this axis 8 and the word “height” will designate a dimension along this axis 8. Finally, “transverse” will mean the direction perpendicular to the translation axis 5 and the vertical axis 8.

The male seal 1 therefore comprises a bearing surface 6 substantially perpendicular to the translation axis 5 and which extends vertically along the axis 8. The male seal also comprises a pressure sensor 7 projecting from the bearing surface 6 in the direction of the female seal 2, along the translation axis 5. The base 9 of the pressure sensor 7 is positioned at the centre of the bearing surface in the transverse direction. The pressure sensor extends vertically over the entire height of the male seal. The base 9 of the pressure sensor is splayed in the direction of the female seal.

The pressure sensor comprises a curved wall 12 positioned against the splayed base. At the end of the curved wall 12 of the pressure sensor, the pressure sensor is provided with a rib 13. This rib 13 comprises a rectangular section with transverse dimensions smaller than the base 12 of the pressure sensor 7. The rib comprises a flat end 14 that faces the female seal. The rib 13 extends vertically over the entire height of the pressure sensor and therefore of the male seal.

The male seal 1 also comprises a first sealing lip 10 positioned at one end 11 of the bearing surface and which extends also over the entire height of the male seal.

The female seal 2 extends vertically over the entire height of the door leaf 4. The female seal 2 comprises a flat bottom 15 positioned facing the pressure sensor. A first branch 16 and a second branch 17 project from this flat bottom 15 in the direction of the male seal 1. The flat bottom 15 and the two branches 16 and 17 extend vertically over the entire height of the door leaf 4. The flat bottom 15 and the two branches 16 and 17 delimit a cavity 18 open in the direction of the male seal 1. The flat bottom 15 comprises transverse dimensions greater than those of the flat end 14 of the rib. The internal walls 19 and 20 of the branches 16 and 17 have a shape complementary to the splayed base 9 of the pressure sensor. The second branch 20 comprises a second sealing lip 21 at its end.

Each branch 16 and 17 comprises an internal rim 27 at the edge of the cavity.

The second sealing lip 21 is inclined in the direction of the pressure sensor 9 while the first sealing lip 10 is inclined in the direction of the cavity of the female seal. The first branch 19 comprises a surface 22 at its end that faces the first sealing lip 10. This surface 22 is inclined with respect to the transverse axis by an angle of between 3° and 35° in the direction of the cavity. Likewise, the bearing surface 23 that faces the second sealing lip 21 is inclined in the direction of the base 9 of the pressure sensor. These inclinations of the sealing lips and of the surfaces that face them guide the sealing lips so that the sealing lips do not turn over during the closure of the set of seals. These inclined surfaces 22 and 23 also limit the friction forces of the sealing lip on the inclined surfaces 22 and 23. In the closed position, the sealing lips 10 and jut during an external pressure and thus prevent any entry of water or dust.

The set of seals is preferably formed from rubber, silicone or EPDM, each seal being extruded.

The curved wall 12 and rib 13 form a deformable rubber envelope 24 that delimits a closed cavity 25 equipped with one or more transducers.

These transducers can be of various types. The set of seals shown in FIGS. 1 and 2 comprises, in the cavity 25, a transducer functioning by virtue of the strong elements being put in contact. These strong elements are situated on the surface 24A of the cavity 25. More precisely, they are distributed over the surface 24A of the cavity 25.

The set of seals in FIG. 3 comprises a transducer for detecting variations in pressure in the cavity 25. More precisely, when the curved wall 12 deforms, the pressure in the cavity 25 increases and it is this variation in pressure that is detected by the transducer.

However, any other type of transducer can be envisaged. It would be possible in particular to envisage transducers functioning by means of the cutting of a light beam. In this case, the transducer would function by virtue of a light beam able to be interrupted by the curved wall 12 when the latter deforms. It would also be possible to envisage producing a transducer by covering the surface 24A of a conductive surface layer the resistivity of which varies according to the deformations of the curved wall 12 or a magnetic surface layer inducing a magnetic field variable according to the deformations of the curved wall 12, the variations in this field being read by a sensitive element disposed opposite on another face of the closed cavity 12A. Any other appropriate means can also be used for defining a cell sensitive to the deformation of the deformable envelope 24.

The male seal and the female seal each comprise a foot 26 able to clip into an aluminium profile on the door leaves 3, 4.

The male seal and female seal are arranged so as to be aligned along the translation axis 5 when the set of seals is in the nominal closed position, as shown in FIG. 1.

With reference to FIG. 1, in the nominal closed position the male seal and the female seal define between them an empty space 28 in the shape of Ω.

In this nominal closed position, the space lying between the bearing surface 6 of the male part and the branches 16 and 17 of the female part form the feet of the Ω, while the space lying between the pressure sensor and the cavity forms the head of the Ω. In this way, the pressure sensor enters deep into the cavity, without however touching the walls of the cavity, which allows an adjustment defect of +/−2 mm along the translation axis and +/−3 mm along the transverse axis.

By virtue of this empty space 28 in the form of Ω, a thin object 29 wedged between the male seal 1 and the female seal 2 must pass in a double chicane with two change-of-direction points and therefore through a double change of angle. This double chicane enables a thin object 29 to be detected when a tension is exerted on it, whatever the direction of this tension.

In order to have an optimum detection of thin objects, the distance between the end of the rib 14 and a straight line passing through the two internal rims 27 is at least equal to half the distance between the two internal rims 27 when the set of seals is in the nominal closed position. This high penetration of the pressure sensor in the cavity also makes it possible to detect thin objects despite adjustment defects of +/−2 mm along the translation axis and +/−3 mm along the transverse axis.

This is because, as shown in FIG. 5, when a tension parallel to the translation axis 30 is exerted on the thin object, the latter bears on the branches 16 and 17, which are relatively non-deformable, which causes a compression of the thin object on the rib 13 along the translation axis.

When a tension parallel to the translation axis 31 is exerted on the thin object 29, it is clear in FIG. 5 that this causes a compression on the rib 13 of the pressure sensor.

When a transverse tension 32 is exerted on the thin object 29, the thin object bears on the two internal rims 27 in order to exert a pressure on the rib 13 along the translation axis.

Thus, whatever the direction of the tension exerted on the thin object, the latter can be detected by the pressure sensor.

The empty space 28 between the male seal and the female seal is sufficiently great to prevent the walls of the cavity bearing on the pressure sensor in the case of an adjustment defect, as can be seen in FIG. 2.

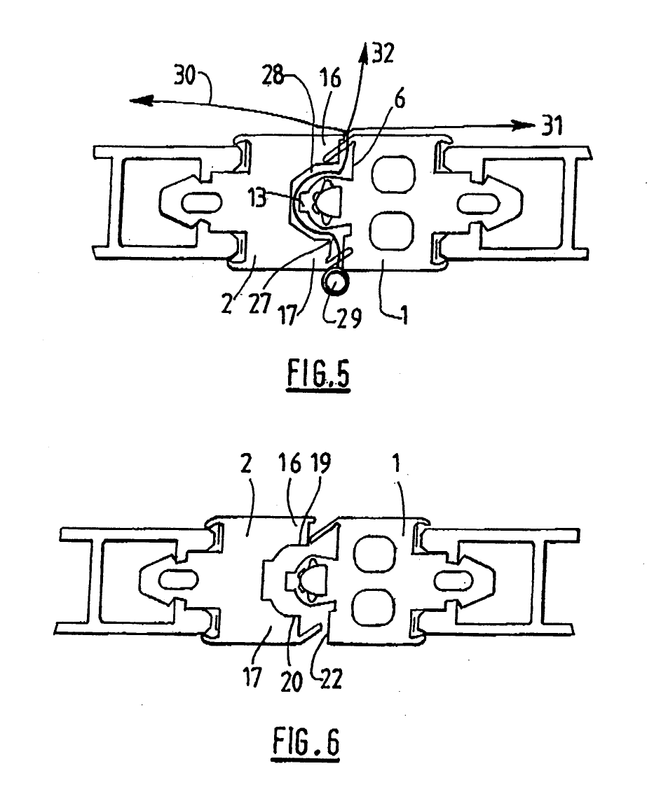

FIG. 6 shows a second embodiment of the invention in which the internal walls of the branches have shapes corresponding to the walls of the pressure sensor so that the pressure sensor 7 can fit in the branches in the event of faulty alignment.

Numerous variations are possible. The invention is for example applicable to a pair of seals one of which is fixed to an opening leaf and the other to a fixed leaf.

1. A set of seals for a door with at least one leaf (3, 4), the set of seals comprising a male seal (1) and a female seal (2), the male seal defining a translation axis, the male seal (1) and the female seal (2) being able to be moved in translation with respect to each other along the translation axis (5) between an open position and a nominal closed position, the set of seals being such that:
the male seal (1) comprises:
a bearing surface (6),
a pressure sensor (7) projecting from the bearing surface (6) in the direction of the female seal (2), the bearing surface (6) extending on each side of the pressure sensor,
the female seal (2) comprises:
a bottom (15) disposed opposite the pressure sensor (7) of the male seal,
two branches (16, 17) disposed on each side of the bottom (15) in order to delimit with the bottom a cavity (18) having a U-shaped cross section open in the direction of the male seal,
the male seal and the female seal being arranged so that, in the nominal closed position:
the two branches (16, 17) are in contact with the bearing surface (6),
the pressure sensor (7) enters the cavity (18) without there being any contact between the pressure sensor and the walls of the cavity.

2. A set of seals according to the preceding claim, characterised in that, in the nominal closed position, the cavity (18) of the female part is conformed so as to delimit, with the bearing surface (6) and the pressure sensor (7), an empty space (28) having a cross section in the shape of Ω.

3. A set of seals according the preceding claim, characterised in that the pressure sensor (7) comprises an end provided with a rib (13) projecting from the wall of the pressure sensor in the direction of the cavity in the female seal.

4. A set of seals according to the preceding claim, characterised in that the rib (13) comprises a flat end (14).

5. A set of seals according to the preceding claim, characterised in that the bottom (15) of the female seal is flat and is disposed facing the flat end (14) of the rib (13) when the set of seals is in the nominal closed position.

6. A set of seals according to the preceding claim, characterised in that set of seals comprises a transverse axis perpendicular to the translation axis (5), the flat bottom (15) having dimensions along the transverse axis at least twice as great as those of the flat end (14) of the rib (13).

7. A set of seals according to any one of claims 4 to 6, characterised in that the cavity (18) and the pressure sensor (7) are sized so that, when the set of seals is in the nominal closed position, the end of the rib (14) is situated at a distance d1 from the bottom (15) of the cavity such that:
0.5 mm<d1<3 mm

8. A set of seas according to any one of claims 4 to 7, in which the pressure sensor (7) comprises two lateral walls (35), each lateral wall (35) facing an internal wall (36) of one of the branches (16, 17) of the female seal, the set of seals being characterised in that the cavity (18) and the pressure sensor (7) are sized so that, when the set of seals is in the nominal closed position, the lateral wall (35) of the pressure sensor is situated at a distance d2 from the internal wall (36) of one of the branches of the female seal such that:
0.1 mm<d2<3 mm

9. A set of seals according to any one of claims 4 to 8, characterised in that:
each branch (16, 17) comprises an internal rim (27) at the edge of the cavity (18),
when the set of seals is in the nominal closed position, the distance between the end of the rib (14) and a straight line passing through the two internal rims (27) is greater than half the distance between the two internal rims (27).

10. A set of seals according to any one of the preceding claims, characterised in that the seal comprises sealing lips (10, 21) closing the empty space (28) between the male seal (1) and the female seal (2).

11. A set of seals according to the preceding claim, characterised in that:
the male seal comprises a first sealing lip (10) arranged so that:
the first sealing lip (10) projects from the bearing surface (6);
the first sealing lip (10) comes into contact with a first of the branches (16) of the female seal;
the first sealing lip (10) is inclined so as to be directed in the direction of the cavity (18);
the female seal comprises a second sealing lip (21) arranged so that:
the second sealing lip (21) projects from the second of the branches (17) of the female seal;
the second sealing lip (21) comes into contact with the bearing surface (6);
the second sealing lip (21) is inclined so as to be directed in the direction of the pressure sensor (7).

12. A door comprising at least a first opening leaf (3) able to move with respect to a fixed leaf or a second opening leaf (4), characterised in that a set of seals according to any one of the preceding claims is fixed to the door, on of the male or female seals (1, 2) being secured to the first opening leaf (3), the other seal (2, 1) being secured to the fixed leaf or second opening leaf (4).

13. A rail vehicle comprising a body provided with at least one door according to claim 12.
